(19) United States
(12) Patent Application Publication
(10) Pub. No.: US 2016/0198685 A1
(43) Pub. Date: Jul. 14, 2016

(54) UPLAND BIRD ENCLOSURE WITH CONTROLLED EGRESS

(71) Applicant: John Julian Huffhines, Austin, TX (US)

(72) Inventor: John Julian Huffhines, Austin, TX (US)

(21) Appl. No.: 14/594,139

(22) Filed: Jan. 11, 2015

(51) Int. Cl. A01K 31/02

(52) U.S. Cl. CPC A01K 31/02

(57) ABSTRACT

An automated protective enclosure for upland game birds is disclosed, where the enclosure includes a unidirectional entry and a mechanical exit that is selective controlled by a controller. By allowing the birds to enter the enclosure and be selectively released based on time or other criteria, the birds can be protected during vulnerable times, therefore increasing their chances for survival while allowing them to acclimate to the wild. Additional optional features for the enclosure include an electronic call for attracting the birds, food and water dispensers with sensors for detecting low-levels, an entry sensor for detecting birds entering the enclosure, temperature sensing and adjusting devices, and a camera for capturing images of birds or other animals entering or proximate the enclosure.

### TECHNICAL FIELD

The disclosure herein relates generally to an enclosure for housing upland game birds, where the enclosure includes control mechanisms for selectively allowing egress of the upland game birds as well as other features to support maintenance of the birds.

### BACKGROUND

Quail and other upland game bird populations are in decline in many portions of the country. Although many attempts have been made to repopulate such upland game birds in the wild, many of these attempts have failed due to predators or the inability to provide constant supervision of the enclosures in which the birds live during the repopulation attempts. For example, enclosures that house live quail can be placed in areas where repopulation is desired, but human interaction is required to facilitate release of the birds. In addition to being unduly burdensome, the human interaction interferes with the adaptation of the birds to the wild. In addition, besides the need for constant monitoring, many such enclosures do not provide adequate features directed to maintaining the health of the birds with minimal effort.

Therefore a need exists for enclosures that support raising upland game birds and acclimating them to the wild in order to facilitate reestablishment of wild populations of such birds.

### BRIEF DESCRIPTION OF THE DRAWINGS

FIG. 1 illustrates a first cutaway view of the upland game bird enclosure in accordance with an exemplary embodiment;

FIG. 2 illustrates an exterior view of a front side of the upland game bird enclosure in accordance with the exemplary embodiment;

FIG. 3 illustrates an isometric view of a unidirectional entry of the upland game bird enclosure in accordance with the exemplary embodiment;

FIG. 4 illustrates an exterior view of a first side of the upland game bird enclosure in accordance with the exemplary embodiment;

FIG. 5 illustrates an exterior view of a second side of the upland game bird enclosure in accordance with the exemplary embodiment;

FIG. 6 illustrates an exterior view of a rear side of the upland game bird enclosure in accordance with the exemplary embodiment; and

FIG. 7 illustrates a schematic diagram of control circuitry associated with the upland game bird enclosure in accordance with the exemplary embodiment.

### DETAILED DESCRIPTION

For simplicity and clarity of illustration, the figures depict the general structure and/or manner of construction of the various embodiments. Descriptions and details of well-known features and techniques may be omitted to avoid unnecessarily obscuring other features. Elements in the figures are not necessarily drawn to scale: the dimensions of some features may be exaggerated relative to other elements to improve understanding of the example embodiments. For example, one of ordinary skill in the art appreciates that the cross-sectional views are not necessarily drawn to scale and should not be viewed as representing proportional relationships between different aspects of the embodiments. Moreover, it should be appreciated that the relative sizing of different aspects of the embodiments may be changed or adapted to suit the particular application in which the enclosure is to be used. For example, the size of the enclosure and entry may be increased to support larger birds or decreased to support smaller birds.

For the sake of brevity, conventional techniques related to construction of enclosures used for housing game birds or other animals may not be described in detail herein. The exemplary embodiments may be fabricated using known construction techniques. There are many inventions described and illustrated herein, as well as many aspects and embodiments of those inventions. As described in further detail below, providing an automated protective enclosure for upland game birds that includes a mechanical exit that is selectively controlled by controller enables birds to be acclimated to the wild and selectively released with minimal human interaction. Minimizing human interaction when raising and releasing birds to the wild helps to facilitate their adaptation to the wild, thereby improving chances for success in reestablishing populations of such birds. While described in the context of upland game birds, the automated protective enclosure described herein can also be used for other wildlife, including other birds or animals.

In one aspect, the described embodiments relate to, among other things, an automated enclosure for upland game birds that includes a unidirectional entry to an interior of the protective enclosure, where the unidirectional entry allows birds to enter the interior but prevents them from the egressing from the interior of the protective structure. In other words, the entry is a one-way entry that makes it easy for birds to get in, but difficult or impossible to get out. A mechanical exit from the interior of the protective structure is provided, where the mechanical exit can be maintained in either an open state or a closed state. The open state allows the birds to egress, and the closed state prevents the birds from the leaving from the interior of the protective structure. A controller, which in some embodiments includes electrically-powered control circuitry, is coupled to the mechanical exit, where the controller selectively actuates the mechanical exit between the open state and the closed state. In some embodiments, the unidirectional entry is located on the lower portion of the enclosure to allow ease of entry for the birds, whereas the mechanical exit is located on an upper portion, thereby helping to prevent predators from entering the structure when it is open, and encouraging the birds to exit the enclosure as a group (e.g. in the case of quail a covey may exit together).

Additional features that can be included to enhance the automated protective enclosure include an electronic call used to encourage the birds to enter the protective enclosure. The electronic call may be coupled to the controller such that the birds are encouraged to enter the protective enclosure at particular times or based on particular conditions. The controller may include a timer to facilitate the control of both the electronic call as well as the mechanical exit. For example, the timing of the movement of the mechanical exit to the open state may be based on the time of day, or based on a certain period of time a lapsing following activation of the electronic call. In such an example, the birds may be encouraged to enter the enclosure to feed at a certain time of day and then allowed to exit the enclosure after a fixed or programmable period of time.

The interior of the protective enclosure is designed to shelter the birds from the elements as well as potential predators. Food and water dispensers are included within the enclosure, where such dispensers may be equipped with sensors to detect the status of those dispensers. For example, a sensor may be provided to detect when the amount of water or food reaches a threshold level. When the sensor detects that the water level is low, that detected condition may result in release of the birds, and alert being signaled (e.g. red light turned on), or transmission of a request to refill the dispenser.

In some embodiments, an entry sensor may be provided in conjunction with the unidirectional entry, where the entry sensor detects entry of a bird. In some embodiments, the entry sensor is a switch, whereas in other embodiments more complex sensors may be employed. For example, the entry sensor may include a radio-frequency identification (RFID) detector/reader. In some embodiments, the protective enclosure is also equipped with a temperature sensor and a heat source, where the temperature sensor is used to determine when supplemental heat should be provided to the enclosure, thereby helping to ensure the temperature supports the needs of the birds. In yet other embodiments, the temperature sensor may be used to send an alert if the temperature exceeds a high or low threshold or trigger a cooling mechanism to reduce the temperature in the enclosure (e.g. a fan or air conditioning unit). A light detector may be included in certain embodiments to allow the time of day or sunrise/sunset conditions to be detected and used in controlling aspects of the operation of the enclosure. A battery can be provided to power the electronics and mechanical movements for the protective enclosure, and, in some embodiments a solar panel, wind turbine, hydro-generator, or other power generating device is used to charge the battery to ensure continuous availability of power.

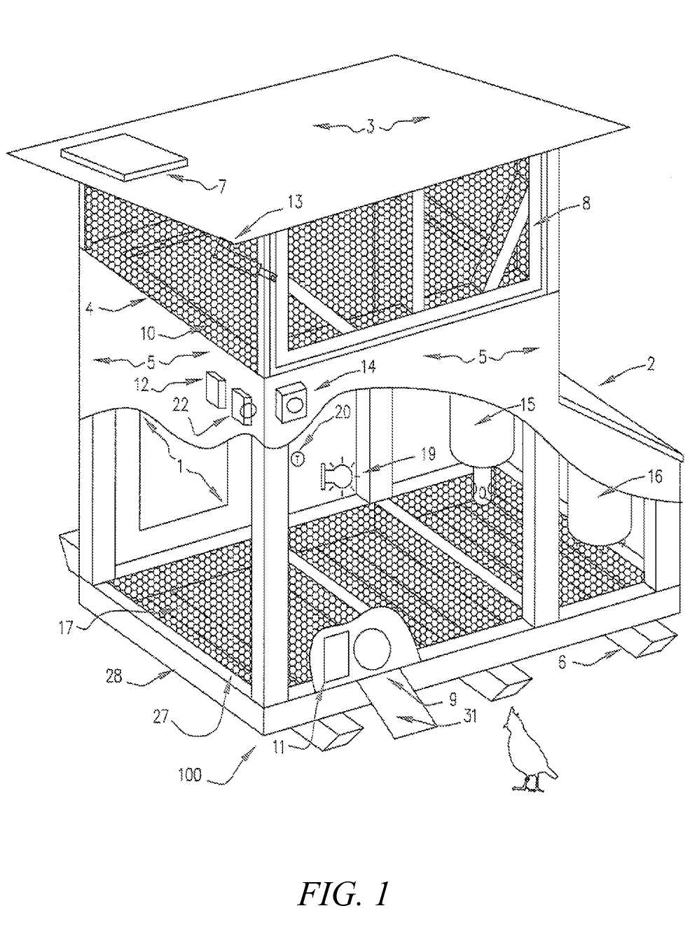

FIG. 1 illustrates a cutaway view of an automated protective enclosure 100 in accordance with an exemplary embodiment. As noted above, while a specific embodiment is provided to help illustrate the various features of the protective enclosure, the specific dimensions, materials, and other aspects of the enclosure may be changed without departing from the scope of the disclosure provided herein. Moreover, while the exemplary embodiment is shown to include a number of beneficial features, other embodiments include different sets or subsets of features, where the combination of features included for each embodiment are selected to best satisfy the needs of the particular application in which the enclosure is to be used. For example, while a supplemental heat source may be more beneficial in an enclosure used in cooler climates, a cooling fan may be more beneficial in hotter climates. In yet other embodiments, both a supplemental heat source and a cooling fan may be included in the enclosure.

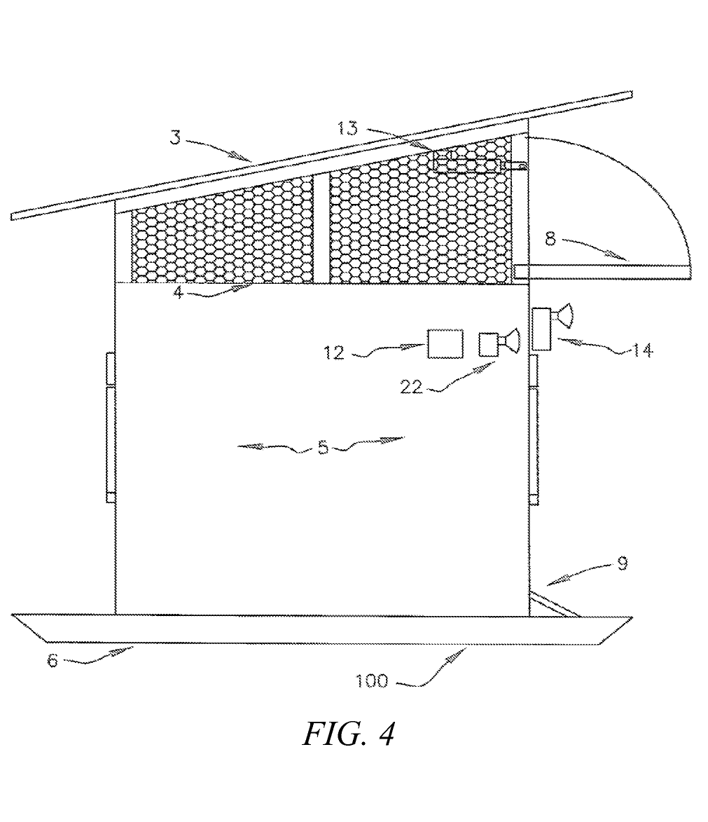

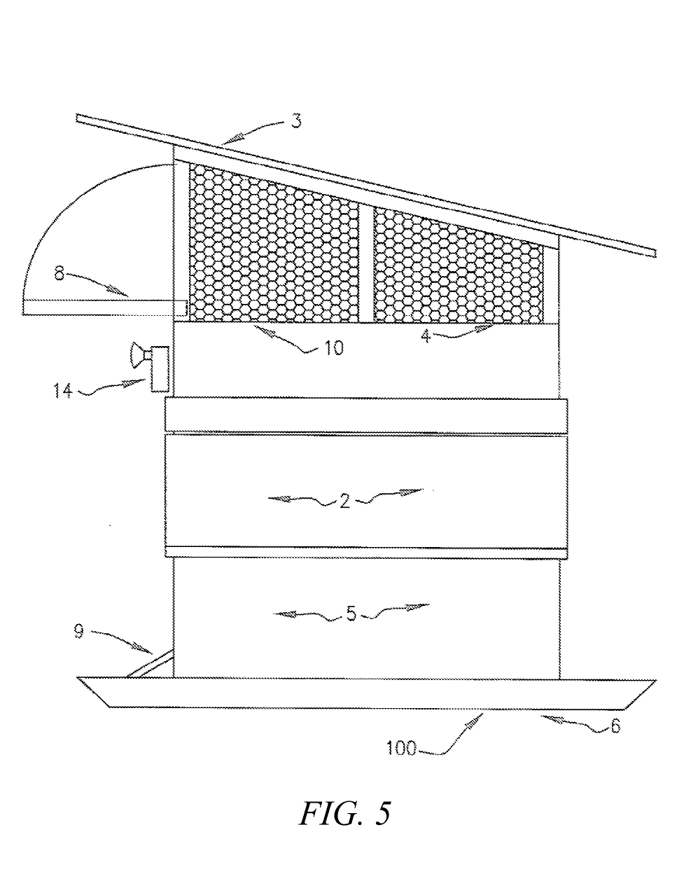

The automated protective enclosure 100 depicted in FIG. 1 includes a unidirectional entry 9 through which birds (or other animals that are desired to enter the enclosure) are able to enter the interior of the protective enclosure 100. The automated protective enclosure 100 includes a mechanical exit 8, which selectively allows egress of the birds from the interior of the protective enclosure. In the embodiment shown in FIG. 1, the mechanical exit 8 includes a door or panel that can be actuated between a first state, which corresponds to the closed state illustrated in FIG. 1, and a second state which corresponds to an open state. FIGS. 4 and 5 provide additional perspective views of the enclosure that depict movement of the mechanical exit 8 between the open and closed states. In some embodiments, the mechanical exit is actuated between these two states using a mechanical actuator 13 that extends to open the door and retracts to close the door. In other embodiments, the mechanical exit includes a mechanical structure similar to a window or sliding aperture that can be opened or closed according to conventional techniques. In yet other embodiments, other mechanical devices used for opening and closing the mechanical exit may be employed, including springs, coils, counter weights, pulleys, etc.

As shown in FIG. 1, the protective enclosure includes a front, a back, a first side, a second side, a floor section, and a top section. Preferably, the top section is covered by a roof 3 which protects the interior of the enclosure from rain, snow, or an overabundance of sunlight. The roof 3 may be equipped with a solar panel 7 that is used to generate power for various aspects of the protective enclosure. In one embodiment, the roof 3 is metal material and is intentionally slanted to avoid accumulation of water, snow, or debris. One of ordinary skill in the art appreciates that various other roofing materials may be used to protect the interior of the enclosure.

The floor section of the enclosure rests on a set of runners 6 that may be used to facilitate movement of the enclosure 100. In one embodiment, the runners 6 are wooden runners (e.g. 2×4″s). In addition to promoting ease of movement of the enclosure, the runners 6 help to elevate the floor section of the enclosure above the ground, thereby allowing waste from the birds to fall through the floor section and not accumulate in the enclosure, which could endanger the health of the birds. Elevating the floor of the enclosure above the ground also helps to facilitate airflow through the enclosure, thereby helping to prevent overheating during the summer months.

In some embodiments, the floor section includes two layers of material separated by a gap. For example, a bottom layer of wire mesh 27 may be attached to the lower portion of a floor section support member 28 and whereas layer of wire mesh 17 is attached to the upper portion of the floor section support member 28. A floor having two layers of material separated by a gap in this manner helps to prevent predators from reaching through the floor section of the enclosure to grasp the birds residing within. In one example embodiment, the layers of material used for the floor section may include ½″ galvanized wire mesh, where the separation between the upper and lower portions of the floor section is on the order of four inches.

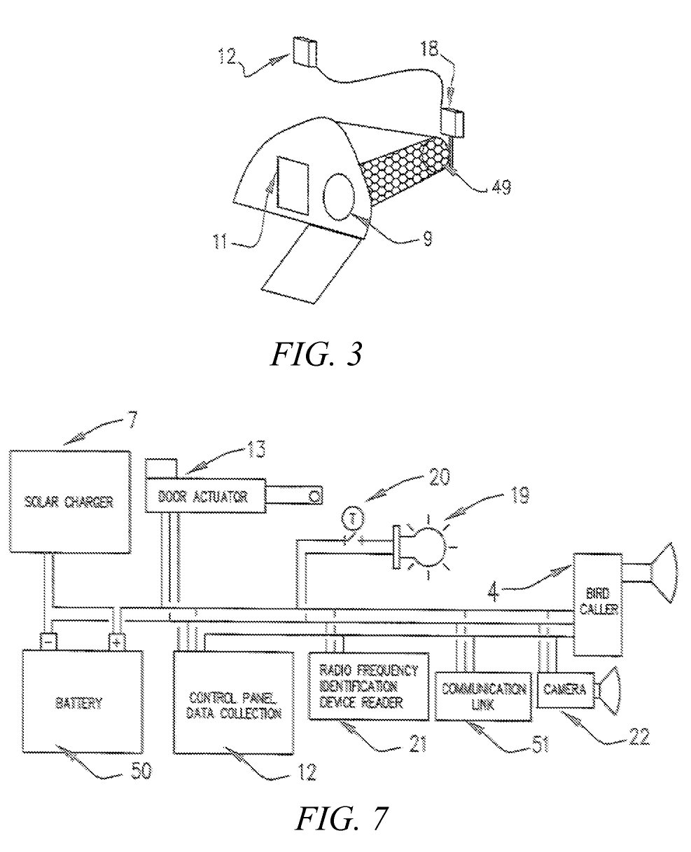

In the embodiment illustrated in FIG. 1, the enclosure 100 includes unidirectional entry 9. Unidirectional entry 9 is shown as an aperture providing access to the interior of the enclosure. Additional detail regarding the entry of birds into the enclosure is provided in the discussion with respect to FIG. 3 below. Accompanying the aperture that provides entry is a ramp 31 that allows the birds to walk up to the height at which the entry is provided. The ramp 31 may help to prevent snakes from entering the enclosure, and, as described in more detail below, may act as a door that can be closed, thereby preventing entry to the enclosure. A mirror 11 may also be provided adjacent to the opening. The mirror 11 encourages birds to pause when they see their reflection, thereby potentially increasing the number of birds that into her the enclosure. In other embodiments, other attractants may be located near the entry 9, including dummy birds, pheromones, a feed dispenser, and the like.

As shown in FIG. 1, the interior of the protective enclosure preferably includes a water dispenser 16 as well as a food dispenser 15. In some embodiments, one or more of the water dispenser 16 in the food dispenser 15 include sensors for detecting when a particular level of food or water has been reached. Such a sensor can be used to trigger an alert that encourages replenishment of the food or water. In some embodiments, the alert may be a light attached to the enclosure that illuminates when the critical level has been reached. In other embodiments, the sensors may be coupled to control circuitry within the enclosure, where the control circuitry causes an alert to be issued in response to the detection of a low level of food or water. Such an alert may include an audible alert, a visual alert, or a transmission (e.g. via RF, WIFI, text message, etc.) of information signifying the low water/food condition. A door 2 is provided on the side of the enclosure proximate to the water dispenser 16 and food dispenser 15 to facilitate replenishment of food and water.

As shown in FIG. 1, the enclosure 100 also includes a rear access door 1 that allows access to the interior of the enclosure for maintenance. While the enclosure depicted in FIG. 1 is boxlike in shape, in other embodiments, cylindrical or other shaped enclosures may be employed. In a specific example corresponding to the embodiment of FIG. 1, the enclosure is approximately 6 feet long and 4 feet wide. In such an example, construction of the enclosure 100 is accomplished using wood and wire mesh. As is shown, the walls are partially wood 5 and partially wire mesh 4. This provides protection from the elements (e.g. wind) within certain portions of the structure, while also providing the birds the ability to see out of the structure through the mesh near the top. The mesh near the top of the structure also provides for ventilation, thereby helping to avoid overheating of the birds in hot climates.

The enclosure includes an electronic call 14 that is selectively engaged to facilitate ingress of the upland birds through the unidirectional entry 9. The electronic call 14 encourages birds to enter the enclosure within which they can be retained until the mechanical exit is actuated to permit their later release. By calling the birds into the enclosure and preventing them from leaving, the birds can be protected from predators during certain parts of the day when such predators are typically preying on the birds. For example, the birds may be attracted to the enclosure 100 just before nightfall and retained until early the next morning. The electronic call 14 preferably mimics the birds call or sequence of calls in a manner that encourages the birds to enter the structure. Such electronic calls are well known in the art. In some embodiments, the electronic call may be capable of mimicking the calls or sequence of calls corresponding to a number of different species of birds. In controlling the electronic call, selectivity with respect to which birds are being called and at what time those particular types of birds are called can be employed to selectively attract different species of birds to the protective enclosure 100. Which calls are used and at what time can be selectable or programmable features (e.g. dip switch, programmable register, controlled by remote programmable device) or hard wired.

The protective enclosure 100 also includes controller 12, which controls some or all of the controllable features included in the protective enclosure 100. For example, in the embodiment of FIG. 1, the controller 12 is coupled to the mechanical exit, where the controller selectively actuates mechanical exit between the first state (open) and the second state (closed). The controller 12 may also be coupled to sensors in the food dispenser 15 and/or the water dispenser 16 to detect low water/food conditions. The controller 12 may also be coupled to an entry sensor 18, which, although not visible in the perspective of FIG. 1, is depicted in FIG. 3. The entry sensor 18 is associated with the unidirectional entry 9, and, in some embodiments, the controller monitors when birds enter the enclosure. Such monitoring can include counting the birds and/or maintaining a time log with respect to bird entry. In some embodiments, the enclosure 100 may be equipped with a camera 22, where the camera 22 is controlled by the controller 12 or by a motion detector such that the camera 22 captures images of birds entering the enclosure or birds or other animals in the enclosure or moving in the proximity of the enclosure.

In some embodiments, the controller may include communication capability such that it can receive and/or transmit data corresponding to the operation or state of the protective enclosure. For example, controller 12 may include or be coupled to a Bluetooth, cellular, or WIFI interface, enabling the controller 12 to transmit or receive data. Examples of data received by the controller may include parameters corresponding to when the mechanical exit 8 should be opened, when a light associated with the enclosure should be turned on, or when the electronic call 14 should be activated to encourage birds to enter the enclosure. Examples of data transmitted by the controller can include status information regarding the food dispenser 15 or water dispenser 16, the number of birds counted entering the enclosure by the entry sensor 18, images captured by the camera 22, current temperature within the enclosure, current exterior temperature, and current settings for various variables associated with control of the features us included in the protective enclosure. In one example, the controller 12 is programmed to control the electronic call 14 to attract a specific species of bird, where the controller 12 sends image data associated with birds entering the unidirectional entry 9 each time a bird enters the enclosure. In such an example, a remote user can control which species of birds are called to the enclosure, where the user is able to monitor the entry of birds into the enclosure via the image data, thereby providing the user with notice as to when the particular species of bird being called has entered the enclosure.

Within the upper portion of the protective enclosure 100, a perch 10 is provided around the interior of the enclosure. The perch 10 allows the birds to rest in a position proximate to the mechanical exit 8. While on the perch 10, the birds can sun themselves and observe their surroundings. As shown in FIG. 1, the mechanical exit 8 is sized in a manner that allows a plurality of the birds to egress the enclosure together in a group. For example, when quail are within the protective enclosure, they are likely to rest on the perch 10 as a group. When the mechanical exit 8 is actuated to the open position, the birds are able to flush (egress) from the enclosure as a covey.

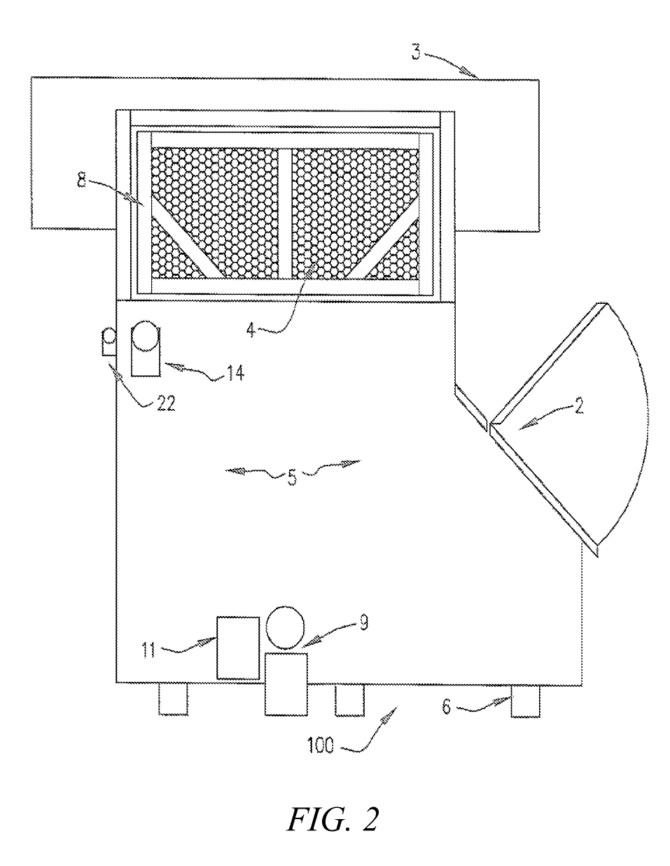

Referring to FIG. 2, a front exterior view of the enclosure 100 is provided. In the perspective provided in FIG. 2, the movement of the door 2 between an open state and a closed state is illustrated. FIG. 2 also provides additional perspective on one embodiment for the mechanical exit 8, which is shown to be constructed of both wood and wire mash. In one embodiment, the mechanical exit 8 shown in FIG. 2 would open by having the lower portion extend away from the front of the enclosure while the top edge of the mechanical exit 8 is hinged to the top portion of the protective enclosure. In other embodiments, the mechanical exit 8 may be hinged on either side, where the actuation pushes the other side out away from the front side of the protective enclosure. As shown in FIG. 2, the roof 3 extends some distance beyond the edges of the various sides of the protective enclosure, thereby providing additional protection from precipitation or sunlight. FIG. 2 also shows a front view of the unidirectional entry 9, which is described in additional detail with respect to FIG. 3 immediately below.

As shown in FIG. 3, the unidirectional entry 9 may include an aperture on the front of the protective enclosure 100, where the aperture provides access to a cone of wire mesh material 49. The cone 49 preferably is tapered in that the proximate portion of the cone adjacent the aperture 9 has a larger diameter then the distal portion most remote from the aperture 9. Moreover, the distal portion of the cone nine is preferably raised above the floor of the enclosure such that while it is easy for birds to exit the cone and drop to the floor, it is difficult for the bird to leave the enclosure by jumping up and going back through the cone 49. In some embodiments, the size of the aperture 9 as well as the proximate and distal portions of the cone 49 is selected to facilitate the entry of certain species of birds or animals, while excluding the entry of other species.

Also shown in FIG. 3 is an entry sensor 18 that detects when a bird enters the enclosure. In some embodiments, the entry sensor 18 may be a switch that is triggered mechanically by the bird as it passes through the distal end of the cone 49. In other embodiments, the entry sensor 18 may be electronic in nature such that it is able to detect birds entering based on a radio frequency identification device or a photovoltaic light beam sensor that is tripped when the bird passes through the light beam. In other embodiments, the entry sensor 18 may be a different type of sensor known in the art or later developed. In the case where the sensor 18 is an RF ID reader, particular birds may be identified based on unique signatures, thereby enabling individual birds to be tracked in terms of their movement in and out of the enclosure. Such an embodiment may be appropriate to a research situation where the researcher is interested in the movements of individual birds.

FIG. 4 provides a side exterior view of the protective enclosure 100. As shown in FIG. 4, the electronic call 14 may be placed directionally aligned with the unidirectional entry 9 such that birds responding to the electronic call are presented with an opportunity to enter the interior of the protective enclosure 100. Also shown in FIG. 4, is the movement of the mechanical exit 8 between the open state and the closed state. A perspective view of the rails 6 is also provided, which shows tapered ends that further facilitate the movability of the protective enclosure 100.

FIG. 5 presents an exterior view of the other side of the protective enclosure 100. The side illustrated in FIG. 5 includes the door 2 that provides access to the food and water dispensers 15 and 16. As is also shown in FIGS. 4 and 5, the roof 3 may extend a significant distance beyond the front and back of the protective enclosure to ensure protection from the elements.

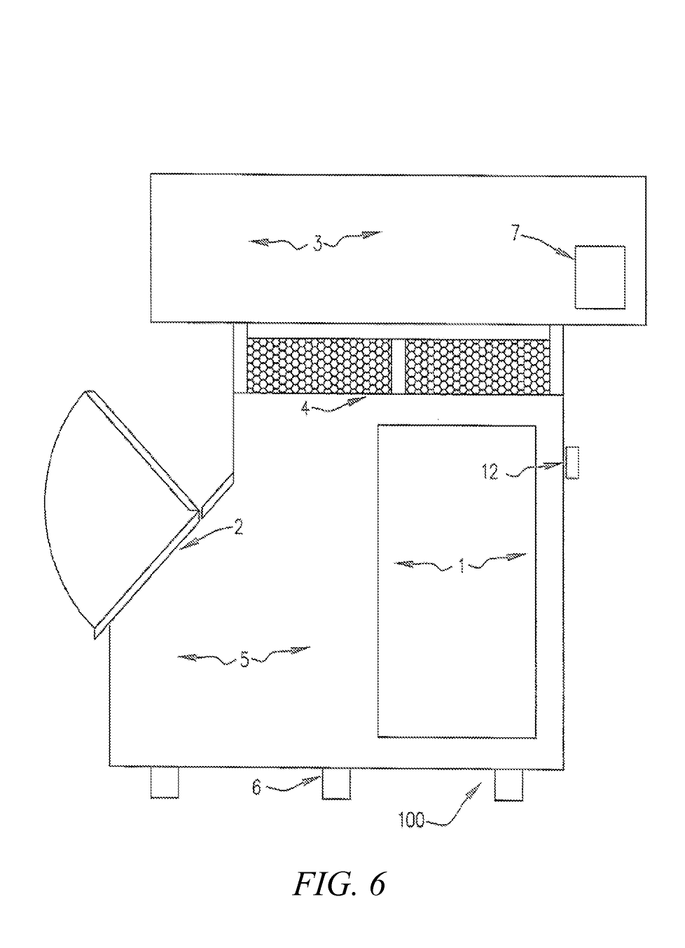

FIG. 6 illustrates a rear exterior view of the protective enclosure, where the rear exterior view also shows the movement of the access door to between the open and closed positions. As is apparent from the rear exterior view depicted in FIG. 6, the roof 3 is sloped towards the rear of the protective enclosure, thereby providing a view of the solar panel 7 on the roof 3 of the enclosure. The access door 1 is also depicted, where, in the embodiment illustrated, the door is of significant size in order to promote easy access to the interior of the protective enclosure for maintenance or other activities.

Turning to FIG. 7, a schematic diagram of the various aspects of the protective enclosure 100 is presented. As discussed above, the controller 12 may be an electrical or electronic controller that relies on a power source to operate. In some embodiments, the controller 12 may include a microcontroller, or some other form of processor, in addition to memory. Software or other forms of instructions may be included in volatile or non-volatile memory to allow the controller to be programmed to perform various operations associated with the features of the enclosure 100. As shown in FIG. 7, controller 12 is coupled to a battery 50 that provides power for the controller 12, the door actuator 13, and the electronic call 14. As shown in FIG. 7, a solar panel 7 can be used to maintain charge on the battery 50, thereby facilitating long-term unattended use of the protective enclosure. As also shown in FIG. 7, a radiofrequency identification device reader 21 may be included as part of the entry detector 18, where the RFID reader 21 provides collected data to the controller 12.

A communication link 51 coupled to the controller 12 allows for data transmission to and from the controller 12, thereby facilitating remote programming as well as delivery of data associated with enclosure operation. As discussed above, the controller 12 may be coupled to a camera 22 for capturing images, a heating element or other temperature control device 19, the electronic call 14, and other accessories associated with the protective enclosure. For example, other alerting devices such as lights may be used, or other attractants to lure desired animals into the enclosure may be provided (e.g. pheromone emitters and the like).

While not depicted in the figures, additional embodiments may include further partitioning within the protective enclosure that enables groups of birds to be contained in smaller groups. For example, small wired enclosures baited with food within the overall enclosure may be used to capture sets of birds to facilitate extraction and transport of those sets of birds. In such an example, a smaller internal holding pen may be used to capture and transport birds. Such holding pens that use bait to capture birds are known in the art. Inserting such pens within the protective enclosure described herein can help in capturing and moving birds in efficient manner, as it may be difficult to capture the birds if they have free run of the entire interior of the protective enclosure. In other embodiments, the interior of the enclosure 100 may be divided into sub-chambers, where the sub-chambers may have different characteristics. For example, multiple sub-chambers may be present where each has different ingress/egress characteristics. In such an example, one sub-chamber may be restricted to only allowing younger birds to enter based on a smaller entryway. In another example, one sub-chamber may be provided with a door to which a transport container may be attached for transporting captured birds, whereas another sub-chamber allows birds to leave by the mechanical exit 8.

In some embodiments, the controller 12 can selectively enable or disable ingress to the interior of the protective enclosure 100. For example, in some cases the controller 12 may be programmed to only allow ingress to the interior during certain times of day or certain weather conditions. Controlling whether ingress to the interior of the enclosure is allowed may be accomplished by the controller actuating a gating mechanism associated with the unidirectional entry 9. For example, an additional door covering the entry 9 may be provided that can be controlled by the controller 12. Specifically, a wire or rope attached to the distal end of the ramp 31 away from the opening 9 may be selectively retracted to close the ramp and block the aperture in a manner similar to a drawbridge. In other examples, the distal end of the entry cone 49 shown in FIG. 3 may be selectively moved to a position that prevents birds or other animals attempting to enter the interior of the protective enclosure 100 from exiting the entry cone 49 within the enclosure. For example, the distal end of the cone may be mechanically shifted from its elevated position to a position even with the floor of the enclosure, where, when in the position even with the floor of the enclosure, the distal end of the cone is blocked by a board or some other obstruction.

In certain embodiments, the enclosure 100 may be constructed in a manner that promotes further mobility of the enclosure 100 by allowing it to become more compact through folding or simple break-down. For example, the various surfaces of the enclosure maybe held together by hinges and easily detached fasteners such that the enclosure can be folded or disassembled for easier transport or presentation on a store shelf.

By providing an enclosure to protect and provide sustenance to game birds that includes a number of controllable features, unmanned operation of such an enclosure is possible, which helps promote adaptation of released birds to the wild while still affording those birds some level of protection and support. Having a mechanical exit that allows the birds to be selectively released and a unidirectional entry enhanced by a mechanical call allows for some control as to when the birds are kept within the enclosure, thereby permitting the birds to be protected during the most vulnerable times. Added features such as a camera, communications link, sensors, and temperature control further enhance the utility of the enclosure.

Although the described exemplary embodiments disclosed herein are directed to an enclosure for helping to populate upland game birds in the wild, the present disclosure is not necessarily limited to the exemplary embodiments, which illustrate inventive aspects that are applicable to a wide variety of animal enclosures. The particular embodiments disclosed above are illustrative only and should not be taken as limitations, as the embodiments may be modified and practiced in different but equivalent manners apparent to those skilled in the art having the benefit of the teachings herein. Accordingly, the foregoing description is not intended to limit the disclosure to the particular form set forth, but on the contrary, is intended to cover such alternatives, modifications and equivalents as may be included within the spirit and scope of the inventions as defined by the appended claims so that those skilled in the art should understand that they can make various changes, substitutions and alterations without departing from the spirit and scope of the inventions in their broadest form.

What is claimed is:

1. An automated protective enclosure for birds, comprising:
a unidirectional entry to an interior of the protective enclosure, the unidirectional entry configured to allow the birds to enter the interior of the protective enclosure, the unidirectional entry configured to prevent egress of the birds from the interior of the protective structure;
a mechanical exit from the interior of the protective structure, the mechanical exit having a first state in which egress from the interior of the protective structure by the birds is prevented, the mechanical exit having a second state in which egress from the interior of the protective structure by the birds is permitted; and
a controller coupled to the mechanical exit, wherein the controller is configured to selectively actuate the mechanical exit between the first state and the second state.

2. The protective enclosure of claim 1, wherein the unidirectional entry is located within a lower portion of the enclosure to allow upland bird entry and the mechanical exit is located on an upper portion of the enclosure.

3. The protective enclosure of claim 2, further comprising a perch proximate to the mechanical exit, wherein the mechanical exit is sized to allow a plurality of birds to egress the enclosure together.

4. The protective enclosure of claim 1, further comprising a timer, wherein the controller is configured to selectively actuate the mechanical exit based on time information provided by the timer.

5. The protective enclosure of claim 1, further comprising an electronic call, wherein the controller is configured to selectively activate the electronic call to facilitate ingress of the birds through the unidirectional entry.

6. The protective enclosure of claim 5, wherein the controller is configured to selectively actuate the mechanical exit from the first state to the second state at a time based on when the electronic call has been most-recently activated.

7. The protective enclosure of claim 1, wherein a time at which the controller actuates the mechanical exit is programmable.

8. The protective enclosure of claim 1, further comprising a dispenser having a sensor configured to detect a threshold dispenser level, wherein the dispenser is configured to dispense at least one of food and water.

9. The protective enclosure of claim 1, further comprising an entry sensor configured to detect entry of a bird through the unidirectional entry.

10. The protective enclosure of claim 1, further comprising at least one of a solar panel and a wind generator to provide power to the protective enclosure.

11. The protective enclosure of claim 1, wherein a floor section of the enclosure is elevated and includes a first layer and a second layer, wherein the first layer is separated from the second layer by a distance sufficient to prevent predators from grasping birds in the interior of the protective enclosure.

12. The protective enclosure of claim 1, wherein the controller includes a communications link configured for at least one of data receipt and data transmission.

13. The protective enclosure of claim 1, further comprising:
a temperature sensor for sensing temperature; and
at least one of a heat source and a cooling device, the at least one of a heat source and a cooling device configured to be activated based on a temperature threshold.

14. The protective enclosure of claim 1, further comprising a camera.

15. An automated protective enclosure for birds, comprising:
a unidirectional entry to an interior of the protective enclosure, the unidirectional entry configured to allow the birds to enter the interior of the protective enclosure, the unidirectional entry configured to prevent egress of the birds from the interior of the protective structure;
a mechanical exit from the interior of the protective structure, the mechanical exit having a first state in which egress from the interior of the protective structure by the birds is prevented, the mechanical exit having a second state in which egress from the interior of the protective structure by the birds is permitted;
a controller coupled to the mechanical exit, wherein the controller is configured to selectively actuate the mechanical exit between the first state and the second state;
an electronic call coupled to the controller, wherein the controller is configured to selectively activate the electronic call to facilitate ingress of the birds through the unidirectional entry.
a battery coupled to the mechanical exit, the controller, and the electronic call; and
a solar panel coupled to the battery.

16. The protective enclosure of claim 15, wherein the mechanical exit further comprises:
a panel; and
an actuator coupled to the panel, the battery, and the controller, wherein the actuator extends a first side of the panel away from a side of the enclosure to move the mechanical exit to the second state.

17. An automated protective enclosure for birds, comprising:
a unidirectional entry to an interior of the protective enclosure, the unidirectional entry configured to allow the birds to enter the interior of the protective enclosure, the unidirectional entry configured to prevent egress of the birds from the interior of the protective structure;
an electronic call, wherein the electronic call is configured to facilitate ingress of the birds through the unidirectional entry when activated; and
a controller coupled to the electronic call, wherein the controller is configured to selectively activate the electronic call.

18. The enclosure of claim 17, wherein a time at which the electronic call is activated is programmable.

19. The enclosure of claim 17, wherein the electronic call supports a plurality of calls, and wherein which call of the plurality of calls is selected for use during activation of the electronic call is selectable or programmable.

20. The enclosure of claim 17, wherein the controller includes a timer and at least one register that stores an indication of a call to be issued by the electronic call, wherein the controller activates the electronic call based on the timer and the at least one register.
